(19) United States
(12) Patent Application Publication
(10) Pub. No.: US 2008/0130509 A1
(43) Pub. Date: Jun. 5, 2008

(54) Leased Line Emulation for PSTN Alarms Over IP

(75) Inventors: Sreedhar Pampati, Fremont, CA (US); Kevin Isacks, Fremont, CA (US); Roger Hook, Tracy, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Network Equipment Technologies, Inc., Fremont, CA (US)

(21) Appl. No.: 11/565,532

(22) Filed: Nov. 30, 2006

(51) Int. Cl. H04L 12/26

(52) U.S. Cl. 370/241.1

(57) ABSTRACT

Techniques for sending and receiving alarm signals over packet-based communication networks are provided. A system for detecting alarm signals on a multiplexed communication line and generating data packets with alarm information is provided. Additionally, a system is provided for receiving data packets with alarm information and generating alarm signals based upon the alarm information of the data packets. The system optionally monitors a connection to a communication network and the status of one or more nodes coupled with the communication network and generates data packets or alarm signals if predetermined conditions are detected.

### BACKGROUND OF THE INVENTION

The present invention relates generally to telecommunications and, more specifically, to sending and receiving communication signals over packet-based networks.

Conventional leased line communication systems carry voice and data signals between two or more locations. At each location, the system generally includes extension devices coupled with one or more switching devices. The switching devices, for example, may be private branch exchanges (PBXs) and the extension devices may be telephones or fax machines. Dedicated trunk lines connect the switching devices and carry signals between them. In a typical system, the trunk lines are time-division multiplexed (TDM) and signals from different extension devices are carried in separate time slots or channels.

FIG. 1 depicts a leased line communication system 100 as known in the art. As shown, local extensions 104 are coupled with a local switch 108a and remote extensions 112 are coupled with a remote switch 108b. Trunk lines 116 connect ports on the local and remote switches and carry voice and data signals between them. Trunk lines 1116, for example, may be T1 lines each supporting a total of 24 multiplexed DS0 channels or E1 lines each supporting a total of 32 multiplexed DS0 channels.

Switches 108 make routing decisions and connect calls between local and remote extensions. When a switch receives a call request, it may use internal routing information to select a port for the call. For example, local switch 108a may receive a call from local extension 104a that requests a connection to remote extension 112b. Using its internal routing information, local switch 108a may select a port for the call that corresponds to a port on remote switch 108b. The signals are then carried on a trunk line 116 that connects the local and remote ports. Remote switch 108b receives the call signals and connects the requested remote extension 112b on the call.

In addition to voice and data signals, trunk lines 116 carry alarm signals between switches 108. Alarm signals may be communicated from one switch to another switch when a failure is detected. Different types of failure may occur. For example, a trunk line may be severed, an operator may take a group of trunk lines out of service to perform maintenance, or problems with a single channel of a trunk line may render that channel unavailable to carry call signals.

Alarm conditions in a leased line system may be variously described according to the type of line, the type of failure, and whether the failure originates locally or is received from a remote source. For example, as known in the art, T1 alarm conditions include may “red alarm”, “yellow alarm”, or “blue alarm.” Different nomenclature may be used with other communication line formats.

By exchanging alarm signals, switches 108 can reroute calls to bypass equipment that has been taken out-of-service. Alternatively, switches 108 can avoid placing a call if an alarm indicates that it cannot be connected to a particular destination. This eliminates unnecessary delays and unnecessary call processing operations.

Over time, packet-based networks have started to replace physical trunk lines in some conventional leased-line communication systems. VoIP systems, for example, enable TDM call signals to be transmitted over private or public packet-switched networks. In these systems, a VoIP gateway may receive call signals from one or more TDM switches and convert them into packetized data for transmission over an IP network.

VoIP systems provide certain advantages over conventional leased line facilities. These may include, for example, eliminating the need to maintain expensive leased lines while continuing to use conventional TDM switching equipment. However, VoIP systems may neglect alarm information contained in the TDM signals or may fail to communicate these alarm signals to other switches in the communication system. This can degrade overall system performance and may prevent TDM switching equipment from operating in an optimal manner. Therefore, there is a need in the art for a system that can manage alarm signals generated by TDM switches when these devices are used with packet-based networks.

### BRIEF SUMMARY OF THE INVENTION

The present invention generally relates to techniques for sending and receiving alarm signals over packet-based communication networks. A system for detecting alarm signals on a multiplexed communication line and generating data packets with alarm information is provided. Additionally, a system is provided for receiving data packets with alarm information and generating alarm signals based upon the alarm information of the data packets. The system optionally monitors a connection to a communication network and the status of one or more nodes coupled with the communication network and generates data packets or alarm signals if predetermined conditions are detected.

In one embodiment, a method of managing alarm signals on a packet-based network is provided. A time-division multiplexed (TDM) signal is received from a local communication device. An alarm signal is detected in the TDM signal that may correspond to a particular channel, port, or trunk group of the local communication device. A message is configured with alarm information and transmitted over the packet-based network.

The method may also include creating a plurality of associations between channels, ports, or trunk groups of the local communication device and corresponding channels, ports, or trunk groups of a remote communication device and maintaining routing information for each of the associations. In various embodiments, the method also includes monitoring the status of a remote communication device on the packet-based network, detecting a failure at the remote communication device or packet-based network based upon one or more parameters, and raising an alarm at the local communication device.

In another embodiment, a method of managing alarm signals is provided in which a message with alarm information is received over the packet-based network. The alarm signals may indicate the failure of a related channel, port, or trunk group at a remote device. The method further includes using the alarm information to send alarm signals to a local communication device.

By sending and receiving alarm signals over packet-based communication networks, the present invention promotes efficient call routing decisions and avoids the unnecessary waste of time and bandwidth associated with failed calls. Advantageously, the present invention can also avoid placing a call if it cannot be completed due to an existing line or equipment failure.

A further understanding of the nature and the advantages of the inventions disclosed herein may be realized by reference of the remaining portions of the specification and the attached drawings.

### BRIEF DESCRIPTION OF THE DRAWINGS

FIG. 1 is a simplified block diagram of a leased line communication system as known in the art.

FIGS. 2A-2B are simplified block diagrams of a communication system according to an embodiment of the present invention.

FIG. 3. is a simplified block diagram of a gateway device 224 according to another embodiment of the present invention.

FIG. 4 shows exemplary data that may be used to perform status monitoring according to embodiments of the present invention.

FIG. 5 is a flow chart showing alarm processing steps according to an embodiment of the present invention.

FIG. 6 is a flow chart showing alarm processing steps according to a further embodiment of the present invention.

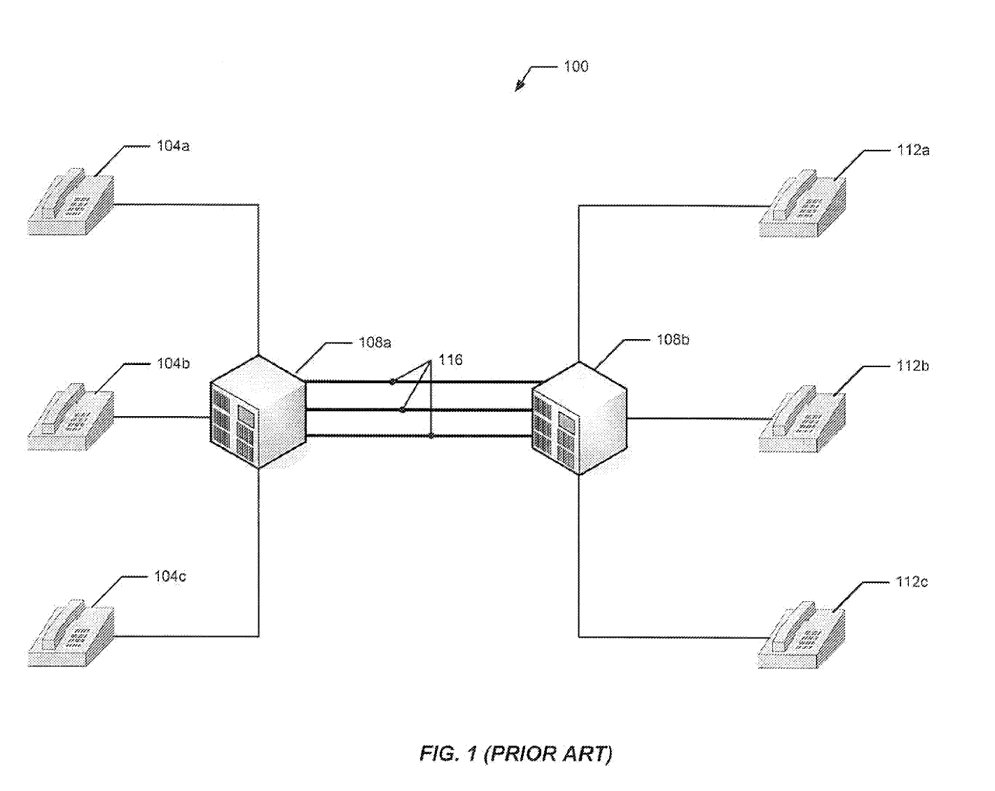

In the drawings, structural or functional elements of the same type may be identified by following the reference label by a secondary designator such as a letter of the alphabet (e.g., 110a, 110b, . . . 110n). If the reference label and secondary designator are both included, the ensuing description is applicable to a specific structural or functional element. Alternatively, if only the reference label is used, the description applies to any of the similar elements having the same reference label.

### DETAILED DESCRIPTION OF THE INVENTION

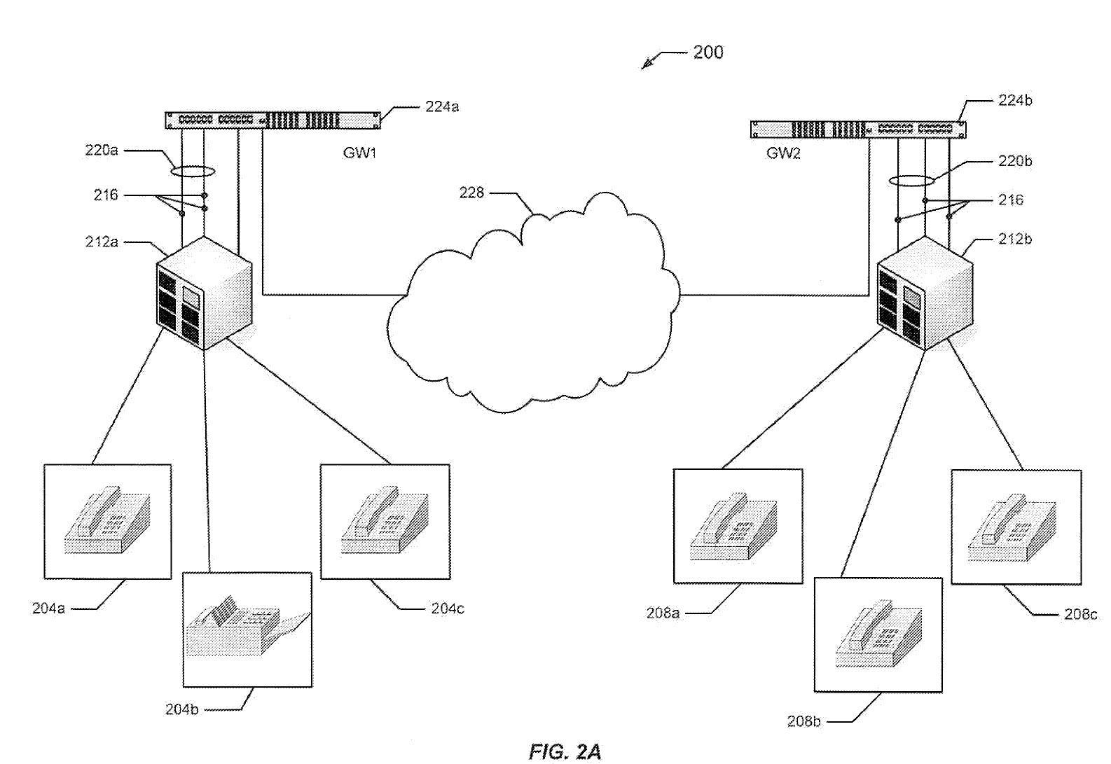

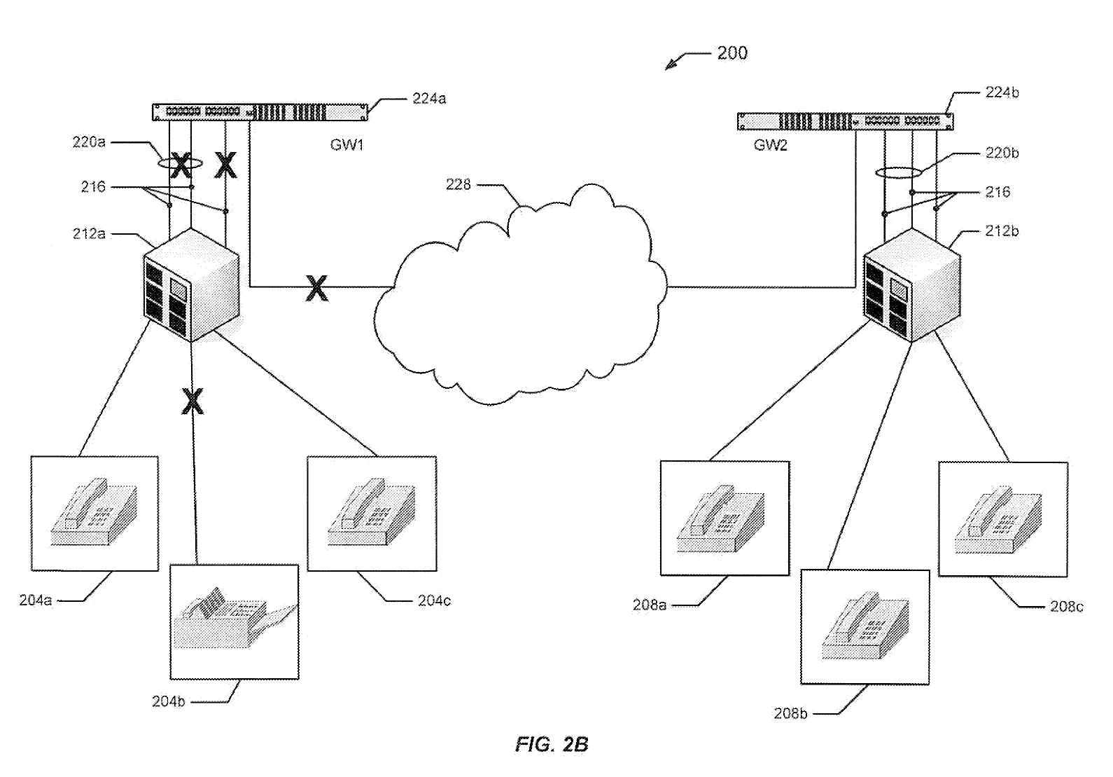

FIG. 2A is a simplified block diagram of a communication system 200 according to an embodiment of the present invention. As shown, communication system 200 includes local extensions 204 coupled with a local switch 212a. Local switch 212a is coupled with a local gateway 224a by trunk lines 216 (also referred to as “trunks”) and local gateway 224a is further coupled with packet-based network 228. A similar arrangement is provided for remote extensions 208, remote switch 212b, and remote gateway 224b.

Local and remote extensions 204, 208 may include telephones, fax machines, modems, and other equipment commonly used with public switched telephone network (PSTN) systems. Extensions generate voice and data signals that are carried by communication system 200.

Switches 212 receive voice and data signals from extensions and multiplex them onto trunk lines 216. Time domain multiplexing (TDM) may be used to create channels or time slots that carry communication signals to and from extension devices. Switches 212 may include conventional circuit-based telecommunications equipment such as private branch exchanges (PBXs), multiplexers, circuit switches, and similar devices. Additionally, in various embodiments, switches 212 may use standard PSTN signaling protocols such as CAS or ISDN/SS7.

Switches 212 include a plurality of ports corresponding to one or more destinations for voice and data signals. For example, switches 212 may be configured with routing information that maps a particular port on the switch to a particular destination. These destinations, for example, may represent other switches in the communication system which are connected through gateway devices as discussed below. Using the routing information, switches 212 may select an appropriate port for transporting the voice and data signals.

In some embodiments, switches at either location may be interconnected to create redundancy. For example, one or more local switches may be interconnected to create primary and backup call routes. Redundancy increases the likelihood that a call will be connected in the event that problems are detected along its primary route. Thus, a primary local switch may have the ability to hand a call off to a backup local switch if equipment or line problems are detected. Remote switches may be interconnected in a similar manner.

Switches 212 are coupled to gateways 224 by trunk lines 216. Individual trunk lines, for example, may connect each port on a switch 212 with a port on its corresponding gateway 224. In various embodiments, trunks 216 are standard T1 or E1 lines and support full-duplex digital communications through separate transmit (TX) and receive (RX) lines. As shown, trunk lines 216 connect ports on local switch 212a with ports on local gateway 224a and also connect ports on remote switch 212b with ports on remote gateway 224b.

Switches 212 detect and respond to alarm conditions (“alarms”). Alarms may indicate line or equipment failures and may occur in connection with either transmit (TX) or receive (RX) signals of a particular trunk. For example, if local switching device 212a is configured for use with T1 lines, it may detect and respond to red, yellow, and blue alarm conditions. As known in the relevant art, alarms may be signaled using individuals bits or bit-patterns on a physical communication line.

Gateways 224 process call signals for their corresponding switches 212. At each gateway, outgoing call signals are received from trunks 216, converted into data packets, and delivered to network 228 for transmission to other devices in communication system 200. Additionally, gateways 224 receive incoming packets at their respective addresses on network 228 and convert the data packets into signaling that is appropriate for their corresponding switches. The converted call signaling may then be delivered by the gateway to a port on its corresponding switch via a trunk line 216.

Gateways 224 also process alarm information for their corresponding switches. As previously discussed, switches 212 are capable of transmitting alarm signals when local line or equipment failures are detected and are also capable of responding to alarms received from remote devices. Gateways 224 enable information about the alarms to be communicated over packet-based network 228. Thus, for example, local gateway 224a may be configured to detect alarm signals generated by local switch 212a and to notify remote gateway 224b of the particular alarm condition detected. Remote gateway 224b may be configured to receive data packets with the alarm information and to communicate this information to remote switch 212b. Remote gateway 224b may be similarly configured to provide alarm notification and receive services to local gateway 224a.

In various embodiments, a one-to-one mapping between local and remote gateways may be created for managing the exchange of alarm information. Thus, for example, a trunk group 220a may be defined at local gateway device 224a that consists of two T1 lines supporting 48 voice channels. Local gateway 224a may associate trunk group 220a with a remote trunk group 220b at remote gateway 224b that also consists of two T1 lines such that each channel of the local trunk group 220a corresponds to exactly one channel of the remote trunk group 220b. In such embodiments, alarm information, for example, may include the channel, port and trunk group (C, P, G) of the alarm source as well as the type of alarm detected. Using (C, P, G) information, gateways 224 can manage alarms at various levels from an entire trunk group down to a single DS0 channel.

Alarm information may be communicated over network 228 using fixed or variable length data packets. Gateways 224 may transmit the packets using various network protocols. For example, in some embodiments, the data packets may be IP packets. In addition, gateways 224 may use various higher-level networking protocols to transport alarm information, manage connections, and provide related services. These higher-level protocols, in some embodiments, may include standard protocols such as SIP or H.323 or they may include specific proprietary protocols.

Network 228 transports data packets between local and remote gateways 224 and may be part of a public or private networking infrastructure. For example, network 228 may be a privately owned IP network that is dedicated to carrying communications between the various parts of communication system 200. Alternatively, network 228 may be a public network such as the Internet.

Referring now to FIG. 2B, the manner in which gateways 224 process alarms according to some embodiments of the present invention will now be discussed. In the figures, alarm conditions are indicated by placing an ‘X’ near a connecting line. It will be understood, however, that these symbols are intended for purposes of illustration and do not represent all possible alarm conditions or the particular sources of alarm conditions. Persons of skill in the art will recognize that many types of line and equipment failures may cause alarm signals to be generated and it is within the scope of the present invention to detect and respond to such alarm signals.

FIG. 2B conceptually illustrates various alarms that may occur at local switch 212a. First, a failure at trunk group 220a is shown. In this situation, for example, the individual trunk lines 216 of trunk group 220a may have failed or may have been taken out of service. As a result, switch 212a may raise an alarm to indicate that it cannot send or receive calls over the particular trunk lines. Gateway 224a may detect the alarm signals and use its mapping data to determine that remote trunk group 220b at remote gateway 224b corresponds to the out-of-service trunk group 220a and should therefore be notified of the alarm condition.

Gateway 224a may generate one or more data packets containing information about the alarm condition. These data packets may include (C, P, G) information for trunk group 220a and may be addressed to remote gateway 224b. The data packets may also specify a particular type of alarm. For example, if switch 212a generated a yellow alarm, this information might also be included in the data packets. In various embodiments, the alarm type may be configurable or specified through device settings. When the alarm condition has been corrected, local gateway 224a may send data packets indicating that service has been restored and that the alarm should be cleared.

When the data packets are received by remote gateway 224b, the alarm information may be extracted. Thereafter, remote gateway 224b may process the alarm information and transmit appropriate alarm signals to remote switch 212b. These signals, for example, may be included as part of the line framing data and may be sent to each of the ports of trunk group 220b. In response to receiving alarm signals, remote switch 212b may take action to reroute calls through a backup switch or to immediately indicate that a call cannot be carried by an out-of-service port.

FIG. 2B also shows trunk and channel level alarm conditions occurring at local switch 212a. When these conditions are detected, local switch 212a may raise an appropriate alarm. By way of illustration, local switch 212a may experience a synchronization error on one of its receive lines and may respond by signaling a yellow alarm at the corresponding transmit line. Similarly, local switch 212a may detect a channel error on a particular trunk line and signal an alarm in response.

Local gateway 224a may receive these trunk or channel level alarm signals and communicate alarm information as previously described. Thus, in the case of a trunk alarm, local gateway 224a may send data packets to remote gateway 224 that identify the failed trunk and specify a type of alarm. Similarly, if a channel alarm is detected, local gateway 224a may send data packets with alarm information to remote gateway 224b identifying the failed channel and indicating a type of alarm. Remote gateway 224b receives these data packets and may communicate the alarm information to remote switch 212b so that calls be rerouted or returned as appropriate.

It will be noted that gateways 224 process alarms for their corresponding switches 212 in both directions over network 228. Thus, each gateway 224 sends and receives packets with alarm information. Consequently, in some embodiments, gateways 224 are configured to perform both local and remote status checks before an alarm condition is cleared. For example, before clearing alarms at a particular port, gateway 224a may check the status of the port at switch 212a and may also check the status of its associated port at remote gateway 224b. If the port passes all status checks, the alarm may be cleared. Otherwise, the alarm may be maintained. A similar procedure may be followed before clearing channel and group level alarms.

FIG. 2B also illustrates a failure in the link between local gateway 224a and network 228. This failure, for example, may represent a situation where the IP connectivity is lost and local gateway 224a can no longer send or receive packets. In some embodiments, gateways 224 are configured to detect network failures at peer devices by periodically sending test messages. If a test message fails, gateways 224 may respond by generating alarm signals at their corresponding switches or by performing additional tests.

For example, in some embodiments, local and remote gateways are configured to exchange ping messages at specified intervals. If these messages are not returned, this may indicate a network failure. As illustrated, ping messages sent to local gateway 224a from remote gateway 224b would not be returned due to network failure. Remote gateway 224b might respond to the failed pings by raising an appropriate alarm for each channel at remote switch 212b that is associated with a channel at local switch 212a. In this way, a network failure at a particular gateway may be made to appear as a general equipment failure to other devices in the communication system.

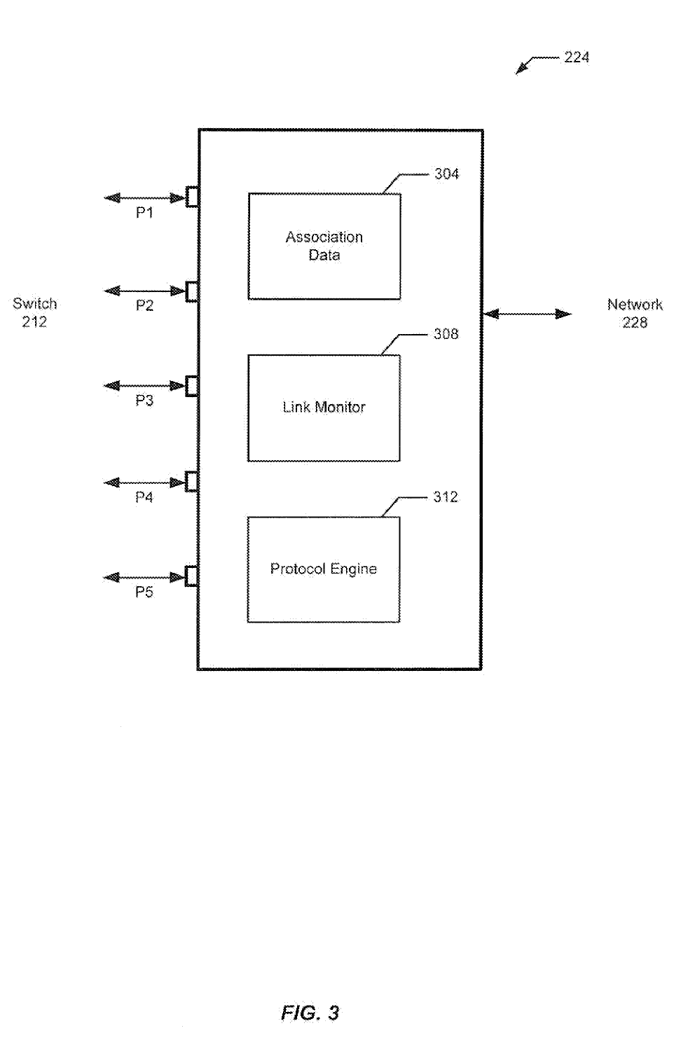

FIG. 3. is a simplified block diagram of a gateway device 224 according to one embodiment of the present invention. As shown, gateway 224 communicates with switch 212 through ports P1-P5 and also maintains a persistent connection with packet-based network 228.

Gateway 224 includes association data 304, a link monitor 308, and a protocol engine 312. These elements cooperate to process alarm information for switch 212 and to emulate a physical connection between switch 212 and other switching devices that may be part of a larger communication network. Gateway 224 effectively hides the existence of packet-based network 228 from switch 212 allowing circuit-based switching equipment to communicate transparently over network 228.

Association data 304 may be used to provide a mapping between switch 212 and other gateways in a communication network. For example, association data 304 may include routing details such as the network address of a remote gateway device that corresponds to a particular channel, port, or trunk-group at switch 212. Association data 304 may be organized at different levels to permit identification of all channels in a particular trunk group or all channels of a particular port with corresponding channels at another gateway in the communication system. As noted, in some embodiments, a one-to-one mapping is created between local and remote channels and related channels are taken out of service or restored to service in tandem. In specific embodiments, association data 304 may comprise a plurality of records stored in a tabular or other data structure

In various embodiments, link monitor 308 generates alarm information for transmission over network 228 and also processes alarm information received from network 228. For example, when alarm signals are detected at switch 212, gateway 224 may access association data 304 to identify the address of a gateway device that should receive notification of the alarm condition. Link monitor 308 may then generate alarm information identifying the type and source of the alarm. The type of alarm, for example, may be a user configurable setting. In specific embodiments, a blue alarm or yellow alarm may be selected.

When packets with alarm information are received at gateway 224, the process may be substantially reversed. Thus, link monitor 308 may receive alarm information carried by the packets and may use the alarm information to generate appropriate alarm signals at a channel, port, or trunk group of switch 212. The alarm signals, for example, may set or clear an alarm condition on one or more trunk lines or individual channels. In this way, for example, gateway 224 propagates alarm information to switch 212 and switch 212 avoids wasting time and network bandwidth when a call cannot be completed on a particular route.

Protocol engine 312 may generate data packets with the alarm information from link monitor 308 and routing information from association data 304. In addition, protocol engine 312 may extract alarm information from received packets and deliver it to link monitor 308 for processing. In some embodiments, protocol engine 312 processes IP data packets using proprietary higher-level protocols to transport the alarm information. In other embodiments, protocol engine 312 may use extensions to a standard protocol network protocol such as SIP to transport the alarm information.

Gateway 224 may actively test the status of a particular channel, port, or trunk group at a peer device. For example, as part of a handshake procedure, link monitor 308 may test the status of one or more mappings contained in association data 304. In some embodiments, link monitor 308 instructs protocol engine 312 to send network messages such as ping messages to a remote gateway requesting the status of a particular channel, port, or trunk group. If the remote gateway responds to the messages indicating that specified channel, port, or trunk group is operational, link monitor 308 may activate the association. However, if a predetermined number of ping messages are sent and a response is not received, link monitor 308 may raise an alarm at the corresponding channel, port, and trunk group of switch 212.

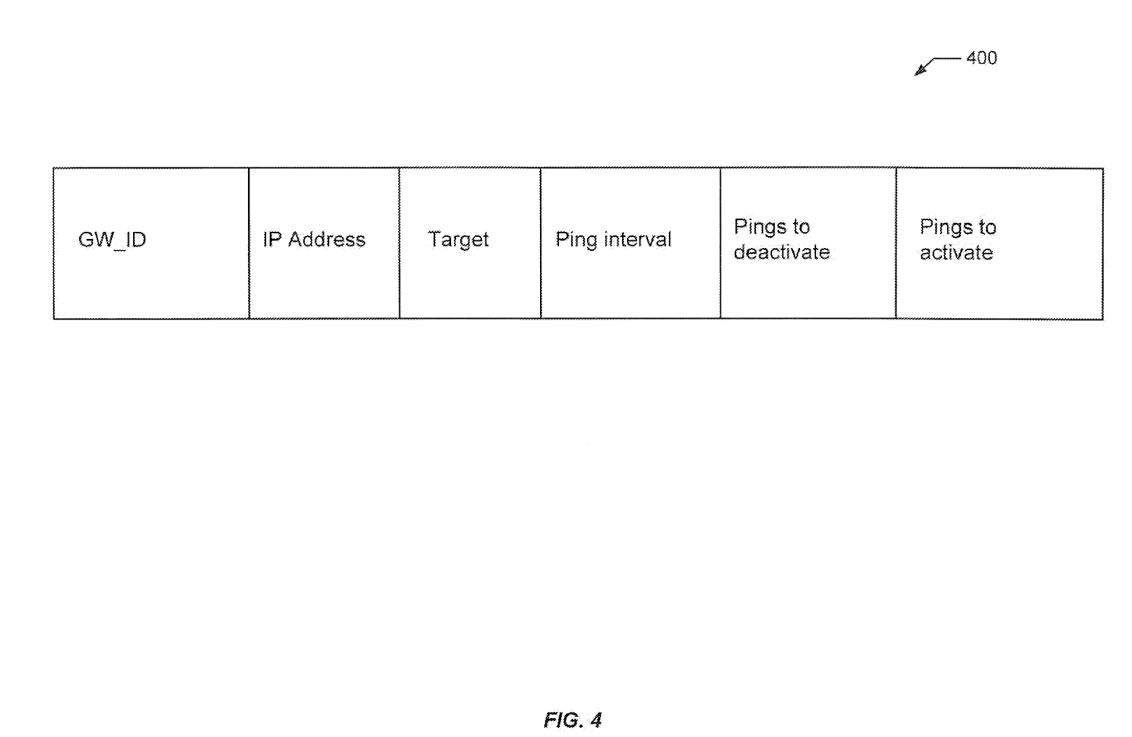

FIG. 4 shows exemplary data 400 that may be used by link manager 308 to determine the status of a channel, port, or trunk group at a remote gateway according to embodiments of the present invention. As shown, data 400 may represent an individual record that may be stored as part of association data 304 or in a separate location. GW_ID, for example, may be the name given to a peer node in a communication system and IP Address may be its address on a packet-based network. Target may represent a particular channel, port, or trunk group (C, P, G) at peer node GW_ID. Additional items such as Ping Interval, Pings to Deactivate, and Pings to Activate may represent configurable parameters. Thus, for example, gateway 224 may be configured to ping a specified remote gateway every seconds (Ping Interval) and to deactivate the target (C, P, G) if a predetermined number of ping messages (Pings to Deactivate) are sent before a response is received. Similarly, if the target is not active, a predetermined number of responses (Pings to Activate) may be required before it will be activated. Each item of exemplary data 400 may be separately configurable by a user of the gateway device.

In some embodiments, link monitor 308 tests the IP link to a remote gateway in a similar manner. For example, if link manger 308 determines that a remote gateway cannot communicate over network 228, alarm signals may be generated on all channels of switch 212 that are associated with the remote gateway.

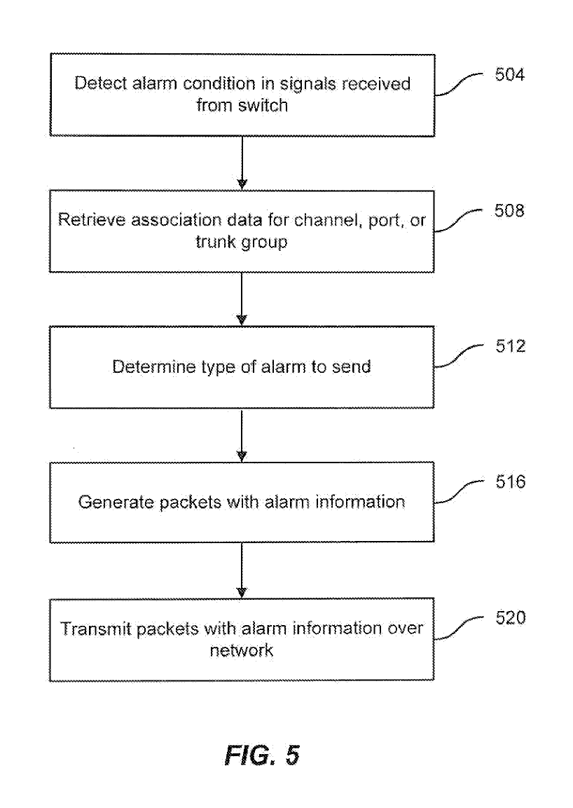

FIG. 5 is a flow chart showing alarm processing steps according to an embodiment of the present invention. At step 504, an alarm condition is detected in signaling received from a switch. The alarm condition, for example, may indicate that a line or equipment failure has occurred. In some embodiments, the alarm condition may indicate the failure of an individual DS0 channel, a trunk line, or a group of trunk lines.

At step 508, association data is retrieved based upon the alarm condition. Association data, for example, may indicate a mapping between the source of the alarm and a remote target. In some embodiments, association data may include a network address of a remote gateway that supports a channel, port, or trunk group (C, P, G) corresponding to a (C, P, G) of the alarm condition.

At a next step 512, a type of alarm is determined for the alarm condition. For example, based upon the alarm signals detected, a yellow alarm or a blue alarm may be appropriate for the alarm condition. Alternatively, the type of alarm may indicate that an alarm condition no longer exists. Thus, in some embodiments, the type of alarm may be used to clear an alarm condition at a remote device. In some embodiments, the type of alarm may be configurable and may be based upon user settings.

When the type of alarm has been determined, at step 516 packets with alarm information are generated. Various types of alarm information may be included with the data packets. For example, the alarm information may include the type of alarm and the (C, P, G) at which the alarm was detected.

At step 520, packets with alarm information are transmitted over a network. In some embodiments, the association data includes a network address of a remote gateway. Accordingly, packets with alarm information may be sent to the remote gateway using this address. In this way, a new alarm condition may be communicated to the remote gateway or an existing alarm condition may be cleared.

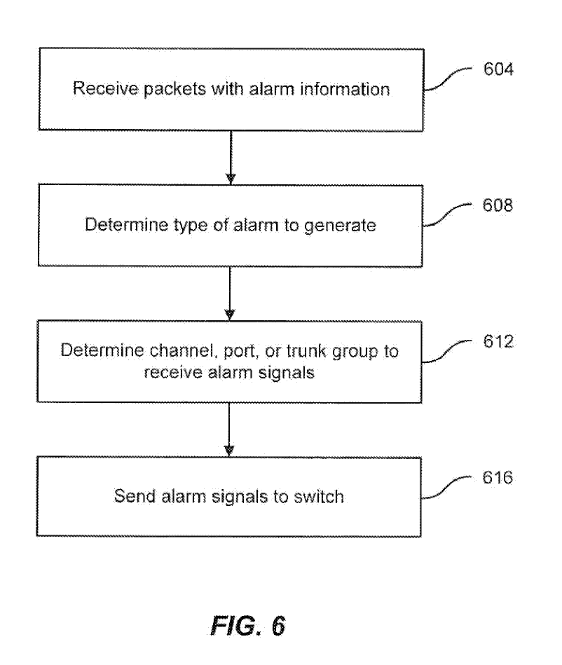

FIG. 6 is a flow chart showing additional alarm processing according to an embodiment of the present invention. At step 604, packets containing alarm information are received at a gateway device. The gateway device extracts the alarm information from the packets and, at step 608, determines a type of alarm to generate. For example, depending upon the alarm information, the gateway may determine that a yellow alarm or blue alarm should be raised at a port (or ports) of a particular switch. Alternatively, as previously discussed, the type of alarm may indicate that an existing alarm condition should be cleared.

At step 612, the gateway determines a channel, port, or trunk group at a switch to receive alarm signals. This (C, P, G) may be associated with the source of the alarm and may be derived from information contained in the received packets. For example, in some embodiments, the data packets may contain an identifier and gateway device may perform a lookup operation using the identifier to determine the appropriate (C, P, G) to receive alarm signals. When the (C, P, G) information and type of alarm have been determined, the gateway device may raise the specified alarm by sending appropriate alarm signals to the switch 616. Alarm signals, in some embodiments, may include specific bits or bit-patterns added to the framing of a particular trunk line.

The present invention may be implemented in digital electronic circuitry, or in computer hardware, firmware, software, or in combinations thereof. An apparatus according to the invention can be implemented in computer program products tangibly embodied in a machine-readable storage device for execution by a programmable processor. The invention can be implemented advantageously in one or more computer programs that are executable on a programmable system including: at least one programmable processor coupled with a data storage system, at least one input device, and at least one output device. Data and instructions may be carried between the programmable processor and other components by a bus or similar architecture as known in the art.

Computer programs of the present invention can be expressed using a high-level procedural or object-oriented programming language, or in assembly or machine language if desired. Program code may be compiled or interpreted. Suitable processors include, by way of example, general and special purpose microprocessors. Generally, a processor will receive instructions from a read-only and/or a random access memory. A computer will typically include one or more mass storage devices for storing data files. These devices may include magnetic disks, such as internal hard disks and removable disks, magneto-optical disks, and optical disks. Storage devices suitable for tangibly embodying computer program instructions and data include all forms of non-volatile memory including, for example, semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

In light of the above disclosure, it will be apparent that the present invention has many applications. The embodiments described cover only a few of the possible variations. Additional variations, combinations of the above embodiments, and related applications will be readily apparent to those of ordinary skill in the art. Therefore, the present invention is not limited in scope to the embodiments described, but should be construed broadly with reference to the appended claims.

What is claimed is:

1. A method of communicating alarm signals over a packet-based network, the method comprising:
receiving a time-division multiplexed (TDM) signal from a local communication device;
detecting an alarm in the TDM signal corresponding to a failure condition associated with the local communication device;
configuring a message with alarm information based on the alarm detected, the message including one or more data packets;
determining an address on the packet-based network of a remote gateway device to receive the message; and
transmitting the message including the alarm information to the remote gateway device over the packet-based network.

2. The method of claim 1 wherein the alarm indicates a failure in at least one of a channel, port, or trunk group of the local communication device.

3. The method of claim 1 wherein the TDM signal is carried by a digitally multiplexed communication line.

4. The method of claim 1 further comprising:
creating a plurality of associations between channels, ports, or trunk groups of the local communication device and corresponding channels, ports, or trunk groups of a remote communication device;
maintaining routing information for each association; and
using the routing information to determine the network address of the remote gateway device.

5. The method of claim 4 wherein the routing information includes status information for each association.

6. The method of claim 5 wherein the status information comprises a local status corresponding to a channel, port or trunk group of the local communication device and a remote status corresponding to a channel, port or trunk group of a remote communication device associated with the remote gateway device.

7. The method of claim 4 wherein the associations create a one-to-one mapping between the channels, ports, or trunk groups of the local and remote communication devices.

8. The method of claim 4 further comprising:
updating the routing information in response to detecting an alarm.

9. The method of claim 1 further comprising:
sending a test message to the remote gateway device over the packet-based network; and
generating an alarm at the local communication device if an expected response to the test message is not received.

10. The method of claim 9 wherein the test message pings a network address of the remote gateway device, and wherein the alarm is generated when a predetermined number of test messages are sent without receiving a response.

11. The method of claim 1 wherein the alarm information is configurable by a user.

12. The method of claim 1 wherein the local communication device is a private branch exchange (PBX), circuit-switch, or TDM multiplexer.

13. The method of claim 1 wherein the message is transmitted using a proprietary network protocol.

14. The method of claim 1 wherein the message is transmitted using a standard network protocol including SIP or H.323.

15. The method of claim 1 wherein the packet-based network is the Internet or a private IP network.

16. A method of communicating alarm signals over a packet-based network, the method comprising:
receiving one or more packets with alarm information over the packet-based network at a local gateway device;
determining a type of alarm based upon the alarm information;
determining one or more ports of a local communication device to receive the alarm; and
generating alarm signals at the one or more ports of the local communication device representative of the type of alarm.

17. The method of claim 16 wherein the alarm information indicates a failure in at least one of a channel, port, or trunk group of a remote communication device.

18. The method of claim 16 further comprising modifying call routing data based upon the alarm information received.

19. The method of claim 16 further comprising:
creating a plurality of associations between channels, ports, or trunk groups of the local communication device and corresponding channels, ports, or trunk groups of a remote communication device;
maintaining routing information for each association; and
using the routing information to identify a channel, port, or trunk group at the local communication device to receive the alarm signals.

20. The method of claim 19 wherein the routing information includes status information for each association.

21. The method of claim 20 wherein the status information further comprises a local status corresponding to a channel, port or trunk group of the local communication device and a remote status corresponding to a channel, port or trunk group of the remote communication device.

22. The method of claim 19 further comprising:
updating the routing information in response to receiving a message with alarm information.

23. The method of claim 16 further comprising:
sending a test message to a remote gateway device over the packet-based network; and
generating alarm signals at the local communication device if an expected response to the test message is not received.

24. The method of claim 23 wherein the test message pings a network address of the remote gateway device, and wherein the alarm signals are generated when a predetermined number of test messages are sent without receiving a response.
